(19) United States
(12) Patent Application Publication
(10) Pub. No.: US 2009/0100462 A1
(43) Pub. Date: Apr. 16, 2009

(54) VIDEO BROWSING BASED ON THUMBNAIL IMAGE

(76) Inventors: Woon Ki Park, Gyeonggi-do (KR); Sung Ho Lee, Seoul (KR); Young Hooi Hwang, Seoul (KR)

Correspondence Address: LEE, HONG, DEGERMAN, KANG & WAIMEY, 660 S. FIGUEROA STREET, Suite 2300, LOS ANGELES, CA, 90017, US

(21) Appl. No.: 12/282,507

(22) PCT Filed: Mar. 9, 2007
(86) PCT No.: PCT/KR2007/001160

§ 371 Date: Sep. 10, 2008

(30) Foreign Application Priority Data
Mar. 10, 2006 (KR) 10-2006-0022536

(51) Int. Cl. H04N 5/445; H04M 1/00

(52) U.S. Cl. 725/38; 455/556.1

(57) ABSTRACT

Provided is video browsing based on a thumbnail image. When video data is selected on the basis of a representative image, thumbnail images generated from the selected video data are continuously displayed. The thumbnail images are sequentially displayed with a set time interval on a window on which the representative image is displayed. The thumbnail images can be enlarged and continuously displayed. Contents of a corresponding video can be recognized in a summarized form using the continuously displayed thumbnail images.

### TECHNICAL FIELD

The present disclosure relates to a video browsing based on a thumbnail image.

### BACKGROUND ART

A thumbnail image provides a user with a method of implying and expressing an entire content or contents of a specific section of a video using a smaller image than an original image. Examples of a method for generating a thumbnail image include a method including decoding a frame of a coded video frame on the basis of MPEG, and directly reducing the decoded frame, and a method using a DC value of an intra frame. In the former case, all pixels of a frame should be decoded, which requires a variable length decoder. In the latter case, since a thumbnail image is generated using a DC of an intra frame, a variable length decoder is not required, and a construction is simple.

FIG. 1 illustrates two types of thumbnail image displaying methods. One type thumbnail image displaying method arranges only a plurality of thumbnail images #1-#9 on a screen 10. The other thumbnail image displaying method displays thumbnail images #1-#5 and corresponding filenames 11 on a screen 12. Images are still images in either case.

### DISCLOSURE OF INVENTION

### Technical Problem

Thumbnail images from video data such as movies and music videos provided as searching data include only still images. It is not considered that a thumbnail image display using only one still image identifies or represents video data. Also, it is not considered that the thumbnail image exactly delivers contents of a corresponding program to a user.

There exist a method of displaying a plurality of thumbnail images for one video data. In this case, the plurality of thumbnail images are displayed on a screen for the one video data. Delivered contents may be affluent as the number of thumbnail images increases, but a huge amount of thumbnail images are generated, so that a burden of a storage medium increases. Also, unnecessary thumbnail images interrupt while a user searches for necessary contents, which causes inconvenience. Also, since a mobile device generally uses a display unit having a limited size, the number of thumbnail images that can be displayed on one screen is limited. Therefore, it is difficult to efficiently imply and express contents of the entire or a section of image data.

### Technical Solution

According to one aspect of the present disclosure, there is provided a method and an apparatus for summarizing and browsing contents of video data on the basis of thumbnail images by generating the thumbnail images from the video data and continuously displaying the generated thumbnail images.

According to another aspect of the present disclosure, there is provided a method and an apparatus for summarizing and browsing contents of a specific reproduction section of video data on the basis of thumbnail images by generating the thumbnail images from the specific reproduction section of the video data and continuously displaying the generated thumbnail images.

According to further another aspect of the present disclosure, there is provided a method for browsing a video, the method including: displaying information used for selecting video data; and continuously displaying thumbnail images generated from the selected video data of displayed video data.

According to still another aspect of the present disclosure, there is provided a method for browsing a video, the method including: displaying an image representing video data; and continuously displaying thumbnail images generated from selected video data of displayed video data on a display window of an image representing the selected video data.

According to yet another aspect of the present disclosure, there is provided a method for browsing a video, the method including: displaying thumbnail images representing video data stored in a portable apparatus; selecting video data on the basis of the displayed thumbnail images; and enlarging a display window of a thumbnail image corresponding to the selected video data, and continuously displaying thumbnail images generated from the selected video data on the enlarged display window.

According to another aspect of the present disclosure, there is provided a method for browsing a video, the method including: displaying thumbnail images representing video data; if video data is selected on the basis of the displayed thumbnail images, performing a summarized browsing of a corresponding video, wherein the summarized browsing includes continuously reproducing thumbnail images generated from a random access point of a video data corresponding to a selected thumbnail image on a display window for a summarized browsing window.

According to another aspect of the present disclosure, there is provided a mobile device including: a storage unit; a decoding unit for reproducing a video and image data; a thumbnail generating unit for generating a thumbnail image from video data stored in the storage unit; a display unit for displaying information used for selecting the video data stored in the storage unit, and continuously displaying thumbnail images of video data selected from displayed video data; and a control unit for controlling the continuous displaying of the thumbnail images generated from the selected video data.

According to still another aspect of the present disclosure, there is provided a mobile device including: a storage unit; a decoding unit for decoding video data stored in the storage unit in real-time to generate thumbnail images from a random access point; a display unit for displaying an image representing the video data stored in the storage unit, and continuously displaying thumbnail images of selected video data on a display window of the image representing the video data stored in the storage unit; and a control unit for controlling the continuous displaying of the thumbnail images of the selected video data.

According to further another aspect of the present disclosure, there is provided a mobile device including: a storage unit; a decoding unit for decoding video data stored in the storage unit in real-time to generate thumbnail images from a random access point; a display unit for displaying a thumbnail image representing the video data stored in the storage unit, and continuously displaying thumbnail images generated from selected video data on an image window of the thumbnail image representing the video data stored in the storage unit; and a control unit for controlling the continuous displaying of the thumbnail images generated from the selected video data.

One or more purposes or implementations of the present disclosure will be described in detail by the accompanying drawings and following detailed description, and other characteristics will become apparent from examination of the detailed description, drawings, and appended claims.

### ADVANTAGEOUS EFFECTS

In a method for reproducing thumbnail images for providing video data, and a terminal using the same according to the present disclosure, a random access point contained in video data is extracted, decoded in real-time, and output to reproduce the thumbnail images, so that a user can easily summarize and recognize contents of video data. Also, according to the present disclosure, one of thumbnail images is selected and simultaneously enlarged and output, so that the selected thumbnail image can be easily discriminated from thumbnail images not selected, and the selected thumbnail image can be more easily recognized.

### BRIEF DESCRIPTION OF THE DRAWINGS

FIG. 1 is a view illustrating an example of a screen on which thumbnail images are displayed;

FIG. 2 is a view illustrating a screen on which thumbnail images are displayed according to an embodiment;

FIG. 3 is a flowchart illustrating a method of displaying thumbnail images according to an embodiment;

FIG. 4 is a view illustrating the construction of a mobile communication terminal according to an embodiment;

FIG. 5 is a view illustrating the construction of a mobile communication terminal according to another embodiment; and

FIG. 6 is a view illustrating an example where thumbnail images are displayed on a mobile communication terminal according to an embodiment.

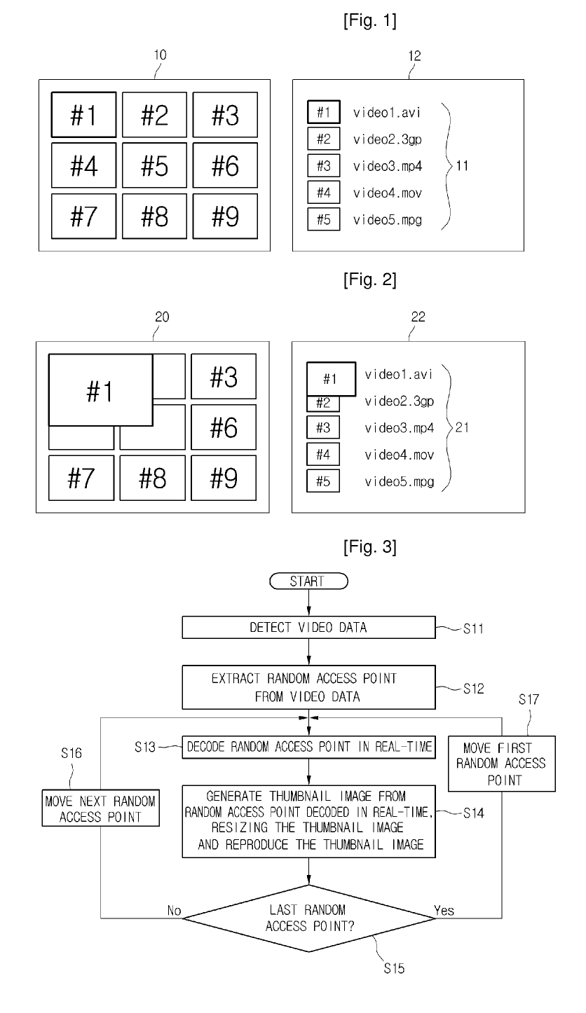

### MODE FOR THE INVENTION

Hereinafter, preferred embodiments of the present disclosure will be described in detail with reference to accompanying drawings.

According to an embodiment of the present disclosure, information for selecting one of video data stored in a storage unit is displayed. When there is one stored video data, information for selecting the one video data is displayed. When there are two or more stored video data, information for selecting one of the two or more video data is displayed. The information for selecting video data can be expressed to include an image extracted from video data, a thumbnail image generated from video data, and one or more data on a list. When one of the displayed video data is selected, thumbnail images generated from the selected video data are continuously reproduced.

According to another embodiment of the present disclosure, information representing a reproduction section of one video data is displayed for the one video data of video data stored in the storage unit. For example, thumbnail images extracted for respective reproduction sections of video data are displayed. The displayed thumbnail images represent reproduction sections, respectively. When one of the displayed thumbnail images is selected, thumbnail images generated from a reproduction section represented by the selected thumbnail image are continuously reproduced.

Though the present disclosure describes the case where one of video data is selected, a video browsing method and a mobile device according to an embodiment of this present disclosure perform the same operation and the same purpose and effect are achieved even in the case where a reproduction section of the video data is selected.

FIG. 2 is a view illustrating a screen on which thumbnail images are displayed according to an embodiment of the present disclosure. In FIG. 2, two types of thumbnail image displaying methods are shown. One method arranges only a plurality of thumbnail images #1-#9 on a screen window 20, and the other method displays thumbnail images #1-#5 together with corresponding filenames 21 on a screen window 22.

The thumbnail images #1-#9 displayed on the screen window 20 are generated by decoding a first intra frame picture included in corresponding video data. The generated thumbnail images are displayed in the form of an icon view. When one of the thumbnail images displayed in the form of the icon view is selected, the selected thumbnail image is enlarged to a predetermined size, and simultaneously, a random access point extracted from a corresponding video data is decoded in real-time to generate a thumbnail image. The generated thumbnail image is reproduced to provide summarized information of the video data. The rest of the thumbnail images that are not selected maintain a state where a first I frame is displayed without a size change.

An image representing video data does not necessarily need to be selected from the first I frame in the previous description and following embodiments. In the above embodiment, only the first I frame of a corresponding video data has been decoded to generate the thumbnail image, and the generated thumbnail image has been expressed as a representative image for convenience in explanation and understanding. For example, an image representing video data may be selected from a proper frame picture within a corresponding video data beforehand or in real-time.

The random access point used in the previous description and following embodiments of the present disclosure can be understood as a key frame depending on cases. An I frame can be selected with a predetermined interval in general from a temporal image flow with reference to an image group of pictures (GOP) structure to designate the selected I frame as a random access point, or a predetermined section including frame arrangement (I/P/B picture) that can predict, recover, and reproduce an image is selected to designate the selected section as a random access point.

The random access point denotes an I frame that is inserted with a predetermined interval and can reproduce an independent image, or a frame arrangement (I/P/B frame picture) that can recover and reproduce an image in a predetermined section in a MPEG series, H.261, and H.264, but the random access point is not limited thereto. All of frames recovered independently regardless of video compression methods, or frame arrangements that can predict, recover, and reproduce an image can be understood as the random access point.

The I frame in an embodiment of the present disclosure means a frame coded only with data of a screen itself without prediction of front and rear frames. A predicted frame picture means a frame generated through prediction from an I frame picture or a previous P frame picture. A bidirectional frame picture is a frame generated through bidirectional prediction of an I frame picture and a P frame picture.

In FIG. 2, the other type screen window 22 includes a plurality of thumbnail images #1-#5 and filenames 21 of corresponding video data. Each of the thumbnail images #1-#5 is displayed using a thumbnail image generated by decoding a first I frame contained in the corresponding video data, and the filenames of the video data are displayed in the form of a list view.

When one of the thumbnail images arranged in a list view is selected, the selected thumbnail image is enlarged in a predetermined size, and simultaneously, a random access point extracted from a corresponding video data is decoded in real-time to generate a thumbnail image, and the generated thumbnail image is reproduced to provide a summarized information of the video data. The rest of the thumbnail images that are not selected maintain a state where a first I frame is displayed without a size change.

A screen configuration of an icon view and a screen configuration of a list view are not limited to the forms shown in FIG. 2, but the screen can display thumbnail images thereon in various forms and arrangements so that thumbnail images are reproduced according to an embodiment of the present disclosure.

In an embodiment of the present disclosure, thumbnail reproduction denotes following two cases. In one case, a predetermined step interval is defined, an I frame is extracted as random access points while movement is made by the predetermined step interval, the extracted random access points are generated as thumbnail images, and the generated thumbnail images are continuously output sequentially or non-sequentially.

In the other case, a frame arrangement of a predetermined time is extracted as random access points while movement is made by the predetermined step interval, and the extracted frame arrangement is reproduced as thumbnail images. Here, in association with the random access point, thumbnail reproduction can be performed in an random order, not an order in which the random access points are extracted.

According to an embodiment of the present disclosure, when a summarized information display command for video data stored in a mobile communication terminal is input, a list of the video data is displayed using thumbnail images on a screen. For this purpose, first I frames contained in the video data are extracted, and the extracted first I frames are generated as thumbnail images to output the generated thumbnail images as representative images of the video data displayed on a screen. At this point, when one of the thumbnail images is selected by moving a selection window of a corresponding thumbnail image, the thumbnail image is enlarged in a predetermined size and simultaneously movement is made to a position at which the selected video data have been recorded, random access points are extracted with a predetermined step interval, and the extracted random access points are decoded in real-time to generate thumbnail images and perform thumbnail reproduction. Also, the thumbnail images not selected maintain and output a still thumbnail image state without a size change.

According to an embodiment of the present disclosure, the size of a thumbnail image is enlarged and simultaneously a random access point of corresponding video data is extracted with a constant or random time interval, decoded in real-time, and generated as a thumbnail image, so that thumbnail reproduction is performed.

According to an embodiment of the present disclosure, the generated thumbnail image is reproduced and displayed on a screen to provide summarized information of video data, and a user can easily understand contents of the video data to easily find desired video data.

A thumbnail reproducing method and apparatus for providing video data proposed by the present disclosure is descried using a mobile communication terminal as an example.

FIG. 3 is a flowchart illustrating a method of displaying thumbnail images according to an embodiment.

When a summarized information display command for video data is input, video data stored in a mobile communication terminal is detected (S 11). The video data can be obtained by shooting an object in real time using a camera provided to the mobile communication terminal, or may be stored video data shot by the camera. Also, the video data can be downloaded and stored from other apparatus or server through a wired or wireless communication device. A first I frame of the detected video data is output so that it is displayed as a representative image. When first I frames of a plurality of video data are displayed as thumbnail images, a screen shown in the embodiment of FIG. 2 is formed. This screen serves as an initial screen of a video browsing interface. A position information of video data corresponding to each thumbnail image is recognized and recorded.

When one of thumbnail images is selected by moving a selection window of a thumbnail image on a screen including thumbnails corresponding to video data, a position at which video data corresponding to the selected thumbnail image is stored is detected. For example, when a thumbnail #1 is selected in FIG. 2, a position at which video data corresponding to the thumbnail #1 is stored is detected.

The selected thumbnail image can be enlarged in its size so that it can be discriminated from thumbnail images not selected. For example, when one of representative thumbnail images displayed on a screen is selected, the size of the selected thumbnail image is enlarged and simultaneously a random access point of a corresponding video data is decoded in real-time to reproduce the thumbnail image. For example, the size of a selected thumbnail image can be gradually enlarged. Assuming that the size of a thumbnail image not selected is ‘1’, the size can be gradually enlarged to 1->1.25->1.5->1.75->2 as time elapses. A maximum size to which a thumbnail image can be enlarged can be controlled, and is not limited to the gradual enlarging method but can be enlarged to a predetermined size at one time. That is, the selected thumbnail image is displayed on a screen while it is enlarged to a predetermined size and simultaneously reproduced, and the thumbnail images not selected are output without a size change. When a selection window of a thumbnail image is moved, a thumbnail image before movement is reduced to its original size, and the thumbnail image located at a position moved is enlarged. Therefore, the selected thumbnail image can be brought into relief so that it is discriminated from the thumbnail images not selected to allow a user to easily recognize contents of video data. Even when the size of a display unit of a terminal is small, the thumbnail image selected by the user is enlarged, the image can be more easily recognized.

Next, movement is made to video data corresponding to the thumbnail image, and a random access point is extracted with a predetermined step interval (S12). Examples of the step interval with which the random access point is extracted include a unit of the number of frames and a time unit based on a reproduction time.

The extracted random access point is decoded in real-time to generate a thumbnail image, and the generated thumbnail image is reproduced with a controlled size, so that the thumbnail image is displayed on a display unit of a terminal (S13 and S14). After that, thumbnail images generated and displayed afterward are thumbnail images generated in real-time from one selected video data, and serve as image information summarizing contents of a corresponding image data.

Examples of a method for generating and reproducing a thumbnail image include a method of analyzing header information of video data to extract codec information of the video data, and decoding a random access point in real-time using the extracted codec information. For example, assuming that a random access point contained in video data is compressed on the basis of an MPEG series, H.261, and H.264, a random access point extracted using a corresponding decoding method is decoded and reproduced in real-time using codec information extracted from the header information.

Thumbnail images to be reproduced can be output on a screen with a predetermined time interval. For example, extracted random access points are decoded in real-time and to reproduce the thumbnail images with the predetermined time interval. For example, when the time interval is set to one second, an I frame extracted as a random access point is generated and output as a thumbnail image. After one second, the next thumbnail image is output. An image frame arrangement of a predetermined time extracted as a random access point is reproduced, and after one second, the next extracted image frame arrangement can be reproduced.

Next, whether a random access point is the last random access point is checked (S15). When the random access point is not the last random access point, movement is made to a next random access point (S16). After the movement is made, the random access point is decoded in real-time to generate a thumbnail (S13). For example, when an n-th (n is an integer where n>2) random access point generated as a current thumbnail image is not the last random access point, movement is made to an (n+1)th random access point, which is the random access point next to an n-th random access point output currently.

When n-th random access point is the last random access point, movement is made back to the first random access point (S17), operations S12 to S14 are performed to extract a random access point, the extracted random access point is decoded, and a corresponding thumbnail image is reproduced. When the last random access point is reached, the last random access point is extracted and decoded in real-time, and a corresponding thumbnail image is reproduced, and then browsing can be ended.

According to another embodiment for thumbnail reproduction, a random access point extracted from the video data is decoded to generate a corresponding thumbnail image, and the generated thumbnail image is stored in a storage unit of a terminal. Referring to FIG. 2, when one of thumbnail images displayed on the screen is selected, the corresponding stored thumbnail image is read and reproduced.

According to another embodiment for thumbnail reproduction, a random access point extracted from video data is stored without decoding. Referring to FIG. 2, when one of thumbnail images displayed on the screen is selected, the stored random access point is decoded in real-time to generate a thumbnail image, and the generated thumbnail image is reproduced.

According to an embodiment of the present disclosure, a random access point contained in video data is extracted and decoded, and a corresponding thumbnail image is reproduced, so that a user can easily check summarized information of video data through recognition based on a corresponding image. Also, since one of thumbnail images is selected and simultaneously the selected thumbnail image is enlarged, the user can easily recognize information of video data.

According to an embodiment of the present disclosure, when a thumbnail image is selected again while the thumbnail image is reproduced, the size of the thumbnail image is enlarged to the size of an entire screen window, and video data corresponding to the thumbnail image is reproduced from beginning or a position of a random access point corresponding to the thumbnail image. Also, only the selected thumbnail image can be reproduced or all of the thumbnail images displayed on the screen window can be simultaneously reproduced.

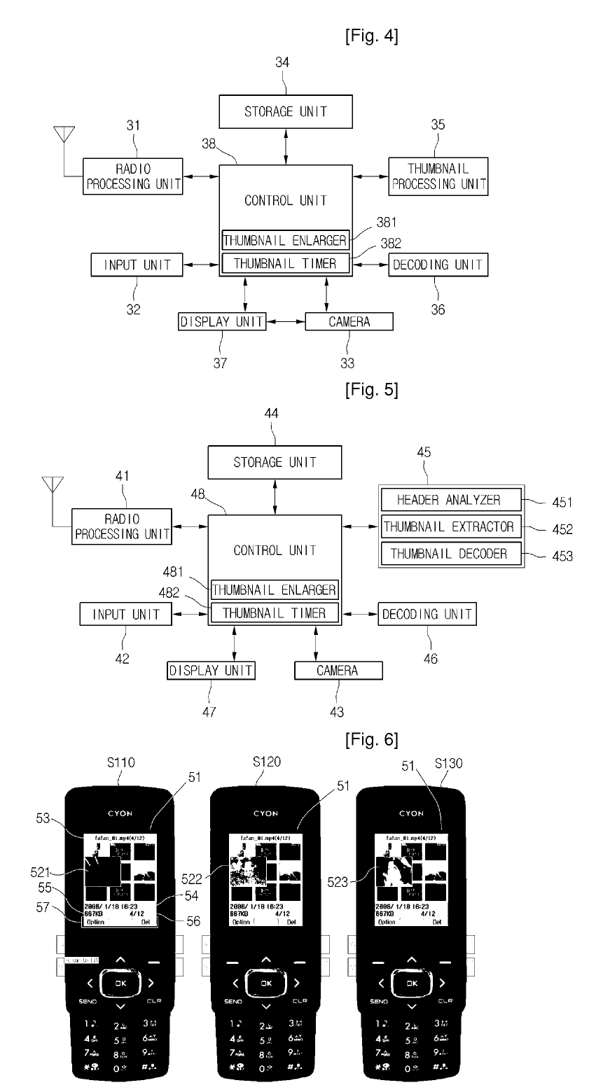

FIG. 4 is a view illustrating the construction of a mobile communication terminal according to an embodiment.

Referring to FIG. 4, the mobile communication terminal includes: a radio processing unit 31 for radio communication with a base station; an input unit 32 for manipulation for using the mobile communication terminal and receiving a command related to a thumbnail image; a camera 33 for shooting an object; a storage unit 34 for storing data such as the shot video or downloaded videos; a thumbnail processing unit 35 for extracting codec information and a random access point of video data; a decoding unit 36 for decoding an extracted random access point and generating a thumbnail image; a display unit 37 for outputting a thumbnail image on a screen; and a control unit 38 for controlling extracting of a random access point, and generating, reproducing, and storing of a thumbnail image. The control unit 38 includes a thumbnail enlarger 381 for enlarging a selected thumbnail image to a predetermined size, and a thumbnail timer 382 for controlling a step interval for extracting a random access point and a reproduction interval of a thumbnail image.

The radio processing unit 31 communicates with a base station of a mobile communication terminal to transmit and receive characters or voice, and image data. The input unit 32 receives commands related to manipulation of the mobile communication terminal, and commands related to video browsing from a user. According to an embodiment of the present disclosure, the input unit 32 serves as a unit for receiving user commands related to thumbnail image processing. The input unit 32 receives commands related to a thumbnail image such as a summarized information display command for outputting summarized information of video data in the form of a thumbnail image, and a selecting command for selecting one of thumbnail images. The camera 33 is a unit for shooting an object to receive the shot object as an electrical signal. The camera 33 can shoot an object in the form of a still image or a video, and can include a camera auxiliary unit such as a light.

The storage unit 34 can include a program memory and a data memory. Examples of the storage unit 34 can include a flash memory, a random access memory (RAM), a read only memory (ROM), and a hard disk drive (HDD). The program memory includes programs for controlling general operations of a portable terminal. The data memory stores video data, a random access point extracted from the video data, and a thumbnail image generated by decoding a random access point.

The display unit 37 displays image data shot by the camera 33, image data stored in advance, or image data transmitted through the radio processing unit 31 on a screen.

The thumbnail processing unit 35 extracts codec information of video data, and extracts a random access point from video data. When a summarized information display command is input through the input unit 32 from a user, the video data stored in the storage unit 34 is detected, and a first I frame is output to display the first I frame as a representative image of the video data on the screen. Examples of displaying the representative image on the screen are shown in FIG. 2.

When a selection command for selecting one of thumbnail images is input through the input unit 32 by the user, the control unit 38 locates a position at which video data corresponding to the selected thumbnail image has been stored. The thumbnail processing unit 35 analyzes header of video data to extract codec information and extracts a random access point from video data with a predetermined step interval.

Here, a selection window of a thumbnail image can be moved using a direction key of the input unit 32 so that a thumbnail image can be selected. The predetermined step interval can be a predetermined time interval. A step interval is designated by checking the thumbnail timer 382 under control of the control unit 38. For example, I frames located with an interval of ten minutes from a first I frame displayed on the screen are extracted and used as random access points. Also, movement is made with an interval of ten minutes from the first I frame displayed on the screen to extract frame arrangements that can be reproduced for five seconds and use the extracted frame arrangements as random access points. The interval for generating thumbnail images or an interval for reproducing and displaying thumbnail images are values set in advance, or values set using the input unit 32 by a user.

A random access point can be designated and inserted into video data. In this case, the thumbnail processing unit 35 can extract a random access point inserted through analysis of the header of video data. That is, the thumbnail processing unit 35 can analyze header information to extract information regarding the number of random access points contained in video data, random access point location information, and can extract a random access point using the extracted information.

The above-extracted random access point is output to the decoding unit 36. The decoding unit 36 receives a random access point and codec information to decode the random access point in real-time, generates thumbnail images, and outputs the generated thumbnail images to the display unit 37. Here, in association with the extracted random access point, actual frame data can be output to the decoding unit 36, or only a file pointer information, which is a frame location information, can be output to the decoding unit 36.

The control unit 38 enlarges the selected thumbnail image to a predetermined size using the thumbnail enlarger 381, and outputs thumbnail images from the decoding unit 36 using the thumbnail timer 382 with a predetermined time interval. The thumbnail enlarger 381 and the thumbnail timer 382 are formed integrally with the control unit 38 or separated from the control unit 38.

When a thumbnail image is selected while the thumbnail image is reproduced, the size of the thumbnail image is enlarged to an entire screen window under control of the control unit 38, and video data corresponding to the selected thumbnail image is read from the storage unit 34 and decoded by the decoding unit 36, so that the video data are reproduced from the beginning, or a selected position.

According to an embodiment of the present disclosure, a thumbnail image displayed on the screen is selected and simultaneously a random access point is extracted and decoded in real-time. The selected thumbnail image is enlarged to a predetermined size, reproduced, and displayed on the display unit 37, so that contents of the video data can be easily recognized.

Another embodiment of the present disclosure relating to a thumbnail processing can be performed as described below.

When a summarized information display command of video data is input through the input unit 32 by a user, video data stored in the storage unit 34 are detected, and a first I frame is output and displayed on the screen as a representative image of the video data. The thumbnail processing unit 35 analyzes header of displayed video data to extract codec information and extract random access points with a predetermined step interval. After the random access points are decoded by the decoding unit 36, thumbnail images are generated, and the generated thumbnail images are stored in the storage unit 34.

When one of the thumbnail images representing video data is selected, a thumbnail image generated and stored in advance is read from the storage unit 34 and reproduced and displayed on the display unit 37 with respect to the video data.

Another embodiment of the present disclosure relating to a thumbnail processing can be provided as described below.

When a summarized information display command of video data is input through the input unit 32 by a user, video data stored in the storage unit 34 are detected, and a first I frame is output and displayed on the screen as a representative image of the video data. The thumbnail processing unit 35 analyzes header of displayed video data to extract codec information, extract random access points with a predetermined step interval, and store the extracted random access points in the storage unit 34. That is, the thumbnail processing unit 35 extracts the random access points of the video data displayed on the screen and stores the same in the storage unit 34.

When one of the thumbnail images representing video data is selected, a random access point stored in the storage unit 34 is read and output to the decoding unit 36, the read random access point is decoded in real-time to generate a thumbnail image, and the generated thumbnail image is output on the display unit 37.

In the above-described embodiments, the size of the selected thumbnail image representing video data is enlarged and simultaneously the thumbnail images corresponding to the video data are reproduced and output on the display unit 37. The thumbnail images output on the display unit 37 are continuously output with a set step interval. The thumbnail images output on the display unit 37 can be continuously output with a step interval on the window of the enlarged size. In the case where the size of the selected thumbnail image representing the video data is not enlarged, the thumbnail images output on the display unit 37 are continuously output with the step interval on the window of the selected thumbnail image. At least two or more thumbnail images output on the display unit 37 can be continuously displayed on one screen, but the thumbnails can be continuously output on one image window corresponding to the enlarged size of the selected thumbnail window. The above-described method for displaying the thumbnail images are applied to all of the above-described embodiments, and also applied to other embodiments described below.

Since thumbnail images are continuously output on the display unit 37, a user can more easily recognize contents of corresponding videos in a summarized form. When a thumbnail image continuously reproduced is selected, corresponding video data is reproduced. The size of a screen on which the video data are reproduced can be switched to the size of an entire screen of the display unit 37.

FIG. 5 is a view illustrating the construction of a mobile communication terminal according to another embodiment. Since a radio processing unit 41, an input unit 42, a camera 43, a storage unit 44, a display unit 47, a control unit 48, a thumbnail enlarger 481, and a timer 482 in FIG. 5 correspond the radio processing unit 31, input unit 32, camera 33, storage unit 34, display unit 37, control unit 38, thumbnail enlarger 381, and timer 382 in FIG. 4, respectively, and operations thereof are the same, descriptions thereof are omitted by referring to the embodiment shown in FIG. 4.

A decoding unit 46 of the mobile communication terminal according to an embodiment shown in FIG. 5 decodes video data. A thumbnail generating unit 45 decodes a thumbnail image. For this purpose, the thumbnail generating unit 45 includes a header analyzer 451 for extracting codec information of a random access point of video data, a thumbnail extractor 452 for extracting a random access point from video data, and a thumbnail decoder 453 for decoding the extracted random access point and generating a thumbnail image. The thumbnail decoder 453 is an embodiment of a thumbnail generator for generating a thumbnail image.

The mobile communication terminal according to an embodiment shown in FIG. 5 includes a first decoding unit for decoding video, and a second decoding unit for generating a thumbnail. Here, the first decoding unit corresponds to the decoding unit 46, and the second decoding unit corresponds to the thumbnail generating unit 45.

When a summarized information display command of video data is input through the input unit 42 by a user, video data stored in the storage unit 44 are detected, and a first I frame is output and displayed on the screen as a representative image of the video data. When a selection command for selecting one of thumbnail images is input through the input unit 44 by the user, the storage unit 44 locates a position of video data corresponding to the selected thumbnail image. The header analyzer 451 of the thumbnail processing unit 45 analyzes header of video data to extract codec information, and the thumbnail extractor 452 of the thumbnail processing unit 45 extracts a random access point from video data with a predetermined step interval.

A selection window of a thumbnail image can be moved using a direction key of the input unit 42 so that a thumbnail image can be selected. The predetermined step interval can be a predetermined time interval. A step interval is designated by checking the thumbnail timer 482 under control of the control unit 48. The interval for generating thumbnail images or an interval for reproducing and displaying thumbnail images are values set in advance, or values set using the input unit 42 by a user.

The extracted random access point is output to the thumbnail decoder 453, which receives the random access point and codec information to decode the random access point in real-time and generate a thumbnail image, and outputs the generated thumbnail image on the display unit 47.

The thumbnail enlarger 481 enlarges a selected thumbnail to a predetermined size, and the control unit 48 outputs thumbnail images output with a predetermined time interval from the thumbnail decoder 453 to the display unit 47 using time information of the thumbnail timer 482.

According to an embodiment of the present disclosure shown in FIG. 5, a thumbnail reproducing operation and a video reproducing operation are performed using the thumbnail decoder 453 for decoding a random access point in real-time to perform thumbnail reproduction, and a decoder 46 for decoding and reproducing video data corresponding to a selected thumbnail image, respectively.

FIG. 6 is a view illustrating an example where thumbnail images are displayed on a mobile communication terminal according to an embodiment.

Here, nine thumbnail images corresponding to nine video data, respectively, are displayed in a three-by-three matrix form on the screen window 51. One of the displayed thumbnail images is selected. Here, a thumbnail image 521 representing video data (fafan_{—}01.mp4) is selected. When the thumbnail image 521 is selected, a random access point contained in the video data (fafan_{—}01.mp4) corresponding to the selected thumbnail image 521 is extracted. Thumbnail images of the extracted random access point are generated, and the generated thumbnail images 521, 522, and 523 are continuously reproduced. Therefore, contents of the video data (fafan_{—}01.mp4) are displayed in a summarized form. In the case where thumbnail images are generated and stored in advance, the stored thumbnail images are reproduced with a pre-determined step interval and continuously displayed. In the case where random access points extracted in advance are stored with respect to video data, thumbnail images corresponding to the stored random access point are generated through real-time decoding, and the generated thumbnail images are continuously displayed with a pre-determined step interval.

In FIG. 6, S110 is an operation for enlarging and displaying a generated first thumbnail image 521, S120 is an operation for enlarging and displaying a generated second thumbnail image 522, and S130 is an operation for enlarging and displaying a generated third thumbnail image 523. Thumbnail images corresponding to video data are continuously displayed with a predetermined time interval on a window of a thumbnail image representing the selected video on a thumbnail reproduction and display screen according to the present embodiment. The thumbnail images generated in real-time with respect to the selected video can be enlarged and continuously displayed as described above, or can be continuously displayed in a size not enlarged.

The thumbnail images generated in real-time with respect to the selected video can be displayed at a different position on a screen.

An example of an operation of browsing videos will be described according to an embodiment of the present disclosure with reference to FIG. 6. It is assumed that header of video data (fafan_{—}01.mp4) selected by a user is analyzed and three I frames are extracted as random access points. Respective random access points are decoded using corresponding decoding methods on the basis of codec information extracted from the header information to generate thumbnail images. The decoded random access points reproduce thumbnail images 521-523 gradually enlarged and generated simultaneously with selection of the thumbnail image 521 of the video data (fafan_{—}01.mp4) to provide summarized information regarding the video data (fafan_{—}01.mp4) to a user.

Assuming that an enlarging ratio for the size of the selected thumbnail image is 2, the size of the thumbnail image is gradually enlarged to 1->1.25->1.5->1.75->2 as time elapses. Assuming that a time interval with which thumbnail images are output is 1 second, extracted three thumbnail images are enlarged and simultaneously output with an interval of 1 second continuously. The above-descried enlarging ratio and an operation thereof are provided as just an example, and not limited thereto.

According to an embodiment of a video browsing screen shown in FIG. 6, a filename 53 or stored date 54 of an video, and the size 55 of a video file corresponding to a selected thumbnail image can be displayed. Also, the number of thumbnail images displayed on a screen window can be displayed, and a menu 57 such as an option menu, a view menu, and a del menu can be provided. The view menu reproduces video data while enlarging the video data corresponding to thumbnail images currently reproduced to an entire screen. The option menu is used to select a reproduction interval, and the del menu is used to del video. The menu 57 is not limited to the menus described herewith, but a variety of menus can be adapted in the art pertaining the present disclosure depending on the various needs associated with video browsing and management.

According to an embodiment of the present disclosure, one of thumbnail images representing video data is selected and simultaneously thumbnail images generated in real-time are gradually enlarged and displayed with respect to the video data. For this purpose, a random access point contained in the video data is decoded in real-time to generate and reproduce a thumbnail image. Also, a selected thumbnail image is emphasized on the screen so that it is discriminated from the thumbnail images not selected to allow a user to easily recognize information regarding video data.

The present disclosure is not limited to a mobile communication terminal, but applied to a portable terminal and a video reproducing apparatus having a video reproducing function such as personal digital assistants (PDAs) and portable multimedia players (PMPs).

While the present disclosure has been described and illustrated herein with reference to the preferred embodiments thereof, it will be apparent to those skilled in the art that various modifications and variations can be made therein without departing from the spirit and scope of the disclosure. Thus, it is intended that the present disclosure covers the modifications and variations of this disclosure that come within the scope of the appended claims and their equivalents.

### INDUSTRIAL APPLICABILITY

The present disclosure can be applied to a mobile communication terminal having a video reproducing function and a terminal such as PDAs and PMPs.

1-26. (canceled)

27. A method for browsing a video, the method comprising:
displaying information used for selecting among a plurality of video files;
displaying at least one of representative images for at least one of the plurality of video files;
receiving an input for selecting a video file among the plurality of video files;
displaying a plurality of thumbnail images which are included in the selected video file and are spaced apart by a predetermined interval.

28. The method according to claim 27, wherein the step of displaying a plurality of thumbnail images comprises,
extracting at least one random access points from the selected video file;
decoding the at least one random access points to generate the plurality of thumbnail images; and
outputting the generated plurality of thumbnail images.

29. The method according to claim 27, the step of displaying a plurality of thumbnail images comprises,
reading out at least one prestored random access points of the selected video file from a storage;
decoding the at least one prestored random access points to generate the plurality of thumbnail images;
outputting the plurality of thumbnail images.

30. The method according to claim 27, wherein the step of displaying comprises,
reading out a plurality of pre-generated thumbnail images for the selected video file; and
outputting the plurality of pre-generated thumbnail images.

31. The method according to claim 27, wherein the information used for selecting includes characters representing each of the plurality of video files or a list of file names for each of the plurality of video files.

32. The method according to claim 27, wherein the step of displaying the plurality of thumbnail images comprises,
enlarging an icon representing the selected video file.

33. The method according to claim 27, wherein the at least one of the representative images are I frames of the selected video file.

34. The method according to claim 27, wherein each of the random access points is one of I frames that are inserted with a predetermined interval and can reproduce an independent image, or a frame arrangement that can recover and reproduce an image in a predetermined section in a MPEG series, H.261, or H.264.

35. The method according to claim 27, wherein the plurality of video files are obtained from a camera in real time.

36. The method according to claim 27, further comprising,
receiving an input for reselecting the selected video file; and
reproducing the selected video file.

37. The method according to claim 36, further comprising, before the reproducing,
enlarging the size of the plurality of thumbnail images.

38. A mobile device comprising:
a storage unit;
a first decoding unit for decoding and reproducing a video file;
a second decoding unit for decoding and generating a plurality of thumbnail images from a selected video file which are spaced apart by a predetermined interval;
a display unit for displaying the reproduced video and the generated plurality of thumbnail images;
an input unit for receiving a command for selecting a video file among a plurality of video files;
a control unit for controlling the storage unit, the first decoding unit, the second decoding units and the display unit.

39. The mobile device according to claim 38, wherein the generated thumbnail images are generated by the second decoding unit in real time from at least one random access points extracted from the selected video file.

40. The mobile device according to claim 38, wherein the at least one random access points are pre-extracted from the selected video file and stored in the storage unit.

41. The mobile device according to claim 38, wherein the plurality of thumbnail images are pre-generated from the selected video file and stored in the storage unit.

42. The mobile device according to claim 38, further comprising a camera, wherein the selected video file is obtained from the camera in real time.

43. The mobile device according to claim 38, wherein the selected video file is selected by the command among characters or a list of file names for representing each of the plurality of video files to the user.

44. The mobile device according to claim 38, wherein when a video file is selected, an icon representing the selected video file is enlarged.

45. The mobile device according to claim 38, wherein the controller directs the first decoder to decode and reproduce the selected video file when an input for reselecting the selected video file is received from the user.

46. The mobile device according to claim 45, wherein the controller directs the display unit to enlarge the size of the plurality of thumbnail images before reproducing the selected video file.
